(19) United States
(12) Patent Application Publication
(10) Pub. No.: US 2024/0225341 A1
(43) Pub. Date: Jul. 11, 2024

(54) Delivery assembly for a machine for preparing beverages, comprising a piercing element for capsules

(71) Applicant: CMA Macchine per Caffè S.r.l., Susegana (TV) (IT)

(72) Inventors: Paolo Nadalet, Belluno (BL) (IT); Andrea Zonelli, Marcon (VE) (IT)

(21) Appl. No.: 18/560,373

(22) PCT Filed: May 13, 2022
(86) PCT No.: PCT/IB2022/054478

§ 371 Date: Nov. 10, 2023

(30) Foreign Application Priority Data
May 14, 2021 (IT) 102021000012563

(51) Int. Cl. A47J 31/06; A47J 31/36

(52) U.S. Cl. CPC A47J 31/0668; A47J 31/3695

(57) ABSTRACT

A delivery assembly for a machine for preparing beverages by using capsule preparations includes an infusion chamber configured for housing the capsule, a delivery unit for delivering pressurized hot water and having a channel for supplying the pressurized hot water toward the infusion chamber, a piercing element for piercing the capsule and having a substantially planar base body and a plurality of blades, an intermediate disc in fluidic sealing connection with the delivery unit, interposed between the delivery unit and the piercing element and having a plurality of through openings in fluidic connection with the channel of the delivery unit. The piercing element has a plurality of holes in fluidic connection with the through openings of the intermediate disc and is placed at least at a radial distance with respect to the center of the piercing element for the passage of the water toward the infusion chamber.

### FIELD OF THE INVENTION

The present invention concerns a delivery assembly for a machine for preparing beverages by using capsule preparations and which comprises a capsule-piercing element. Moreover, the present invention concerns such a piercing element and a respective method of manufacturing.

### KNOWN PRIOR ART

Machines for preparing beverages (in particular coffee machines) to be used with products for capsule infusions (hereunder also denoted as preparations or ingredients) and comprising means for housing a capsule and piercing devices for piercing the latter for the passage of the infusion water inside the capsule, through an inlet surface and an outlet surface of the capsule, are known in the art.

The piercing devices of such machines comprise a housing for the capsule (which generally has a cylindrical or truncated cone shaped body) and piercing elements, for examples needles or points, which can comprise inner channels, such as to simultaneously allow the opening of the upper and/or lower part of the capsule and the formation of the channel for delivering the pressurized hot water inside the capsule.

The disadvantage of such devices is that the channels present inside the piercing elements (needles or points) can be obstructed, during use, by the limestone present in the water or by the ingredient, for example coffee, which can come into contact with the piercing elements during the infusion.

Moreover, the channels present inside the piercing elements can further be obstructed, during use, by the film or skin generally used to close the inlet and/or outlet surfaces of the capsule itself, which can tear after the piercing and thus possibly obstruct the channel for the passage of the water.

Systems which provide channels for delivering the water that are not made inside the elements for piercing the capsule, for example possibly in the shape of blades, are also known.

A further disadvantage of the known systems is the fact that they require a high number of piercing elements to ensure uniform wetting of the powder ingredient contained inside the capsule. Moreover, the piercing elements of the known art are not distributed such as to ensure uniform wetting of the product.

Moreover, a further disadvantage is the adhesion that is generated between the skin or film of the capsule and the piercing elements, which causes non-optimal and non-uniform wetting of the product contained inside the capsule.

Moreover, piercing elements made from sheets of material by means of CNC processes, or by molding technopolymers, are known in the art.

Such techniques are not very appropriate for making complex geometries and also require long times and high costs.

### SUMMARY OF THE INVENTION

Object of the present invention is to allow uniform wetting of the ingredient, preferably powdered, contained inside a capsule, such as to achieve an optimal infusion of the ingredient, thus eliminating the preferential paths that can be generated with the machines of the known art when piercing the film of the capsule.

Further object of the present invention is to prevent the film or skin sealing the capsule from adhering to the surface of the piercing elements, for example blades or points, such as to allow a constant and optimal flow of water inside the capsule.

This improves the distribution of the water to achieve a correct infusion of the ingredient, for example coffee.

Further object of the invention is to make a piercing element which has a complex geometry appropriate for the optimal piercing of the capsule and that is however simple and economic to produce compared to the piercing elements of the known art.

These and further objects are reached by means of a delivery assembly according to claim 1, and of a piercing element according to claim 17 and of the respective method of manufacturing according to claim 19.

According to the invention, the infusion assembly, appropriate for a machine for preparing beverages by using capsule preparations (ingredients or products), comprises
an infusion chamber into which the capsule is at least partially inserted during use
a delivery unit for delivering pressurized hot water, comprising at least one channel for supplying pressurized hot water towards said infusion chamber,
a piercing element for piercing said capsule, comprising a substantially planar base body and a plurality of blades,
an intermediate disc in fluidic sealing connection with said delivery unit and interposed between said delivery unit and said piercing element, comprising a plurality of through openings in fluidic connection with said channel of said delivery unit,
wherein the piercing element has plurality of holes in fluidic connection with the through openings of the intermediate disc and placed at least at a radial distance d′ with respect to the center C of said piercing element for the passage and distribution of the water towards the infusion chamber and then into the capsule housed therein.

Advantageously, such a configuration of the delivery assembly, comprising a delivery unit for delivering pressurized hot water in fluidic connection with the intermediate disc and the piercing element provided with blades, allows uniform wetting of the powder ingredient contained inside the capsule.

Advantageously, the presence of a plurality of holes allows more uniform wetting of the powder ingredient inside the capsule and in fact allows to prevent the formation of preferential water paths that cause non-uniform wetting of the ingredient contained inside the capsule.

According to an aspect, the holes are placed at the same radial distance with respect to the center of the piercing element.

According to a further aspect, the holes are arranged on the base body of the piercing element along a circumference of radius, with respect to the center C, substantially equal to the radial distance at which the through openings of the intermediate disc are arranged.

According to an aspect, the blades are made in one piece with said piercing element and extend from said base body, in particular from the surface of the base body, to project towards said infusion chamber and thus towards the water inlet surface of the capsule.

Preferably, each blade is made from a portion of said piercing element folded up to project towards said infusion chamber.

The making of the piercing blades of the capsule in one piece with the body of the piercing element allows to simplify and reduce the costs of the productive process.

Moreover, according to a further aspect, at least one blade, preferably each blade of the piercing element, has an opening extending from the base body of said piercing element along the direction of longitudinal extension of the blade. The central openings are placed in fluidic connection with said through openings of the intermediate disc.

Advantageously, the presence of such openings allows to prevent the blades from adhering with the film or skin sealing the capsule and also allows an optimal and constant flow of water towards the inside of the capsule.

According to an aspect, the piercing element comprises proximal blades placed at a first radial distance r with respect to the center C of said piercing element, preferably along at least one first circumference of radius r equal to such first radial distance r, and a plurality of distal blades placed at a second radial distance R greater than said first radial distance r with respect to the center C of said piercing element, preferably along at least one second circumference of radius R equal to such second radial distance R.

Advantageously, the presence of such blades at different distances with respect to the center of the piercing element has the purpose of allowing the uniform percolation of the coffee, thus without creating preferential paths for delivering the water inside the capsule and thus of achieving uniform wetting.

According to an aspect, the through openings are placed at a radial distance d with respect to the center C1 of such intermediate disc and put said channel of said delivery unit in fluidic communication with a circular channel of said intermediate disc.

According to an aspect, the circular channel of the intermediate disc is shaped as a groove extending along a circular crown about the center of the intermediate disc, on the surface of the intermediate disc facing the infusion unit.

Moreover, according to an aspect, the piercing element is connected with said intermediate disc such as the through openings of the intermediate disc are overlapping the holes of the piercing element.

It should be stated that herein and hereunder, the term “overlapping” does not necessarily mean that two elements fully match and are thus aligned. In other words, the term overlapping intends to mean that the two elements, for example the through openings of the intermediate disc and the through openings of the piercing element, are arranged respectively on two planes (preferably parallel or substantially parallel) overlapping each other, but not necessarily that such elements arranged on two different places are aligned with each other, but that they can thus be arranged at angular intervals.

For example, according to an aspect, it is to be understood that the holes of the piercing element are arranged on the base body of the piercing element along a circumference of radius d′ substantially equal to the radial distance d at which the through openings of the intermediate disc are arranged.

According to an aspect, the delivery unit, the intermediate disc and said piercing element are connected to each other by means of mechanical connecting means, preferably by means of a screw. Preferably, the connecting means are of the removable type and thus allow the simple and quick installation/removal of the intermediate disc and piercing element from the delivery assembly.

This way, a delivery assembly, for example of a machine for delivering espresso coffee, can be adapted for use with capsule preparations (products or ingredients) by installing the intermediate disc and the piercing element in the delivery assembly by the connecting means, for example a screw.

According to an aspect, the piercing element is made from a sheet or foil, preferably a sheet or foil of metal material.

According to a further aspect, the blades are substantially triangular-shaped. In other words, the blades are jutting out from the base body, and in particular from the surface of the base body that is, in use, facing the capsule and thus facing the infusion chamber, with two sides that are inclined to each other, such as to form a point at the junction (incidence) point of the two sides.

Moreover, the blades extend from the base body of said piercing element towards the inside of said infusion chamber along a direction of longitudinal extension which has an angle between 70° and 110°, preferably between 80° and 100°, more preferably substantially equal to 90°, with respect to the base body, and in particular to the surface of the base body, of the piercing element.

Advantageously, such configuration allows an optimal piercing of the capsule.

According to an aspect, the openings have a substantially linear shape extending between two ends, where a first end is placed at the base body of the piercing element and a second end is placed on the body of the blade.

Advantageously, such configuration, in which part of the opening of the blade is placed at the base portion of the piercing element, allows to prevent the surface of the capsule from adhering to the piercing element. In fact, the water can pass through such opening, further ensuring better wetting of the ingredient contained inside the capsule.

According to an aspect, each of the openings extends along the respective blade between the first and second ends, thus forming an angle between 70° and 110°, preferably between 80° and 100°, more preferably substantially equal to 90°, with respect to the base body, in particular to the surface of the base body, of the piercing element.

According to a further aspect, the infusion unit is a filter-holder provided with a handle, said filter-holder being removably constrainable to said delivery unit by connecting means.

Advantageously, the delivery assembly according to the invention can be used with a filter-holder, for example of the type used in the common machines for preparing espresso coffee. The capsule is housed at least partially inside the infusion chamber, i.e. the volume of the filter-holder body configured for housing the capsule. In order to cause beverage to exit, the infusion chamber, and in particular from the filter-holder, can be provided, at the bottom (or lower part) thereof, with piercing means for piercing the capsule, for example needles or points, or the capsule can already be open on the bottom (beverage outlet section), or the capsule can provide outlet means which allow the beverage to exit upon reaching a given pressure inside the capsule, caused by the infusion water entering therein.

Object of the present invention is also a piercing element comprising a substantially planar base body which has a plurality of blades, preferably a plurality of holes in the base body, and wherein the blades are made in one piece with the piercing element and each blade is made from a portion of said piercing element folded up for extending from the base body, and in particular from the base surface, of the piercing element, along a direction of longitudinal extension which has an angle between 70° and 110°, preferably between 80° and 100°, more preferably substantially equal to 90°, with respect to the base body of the piercing element.

According to an aspect, at least one blade, preferably each blade, has an opening, preferably a central opening, extending from the base body of the piercing element along the direction of longitudinal extension of the blade. As discussed above, the presence of such openings advantageously allows to prevent the skin or film closing the inlet wall of the capsule from adhering to the blade, thus limiting or anyhow modifying the path of the water coming into the capsule. Moreover, the openings allow the passage of the water through them.

Moreover, object of the present invention is a method of making a piercing element described and/or claimed herein, wherein the piercing element is made from a sheet or foil preferably of metal material, the method comprises a first cutting step (a), preferably laser cutting or photoengraving cutting, wherein the sheet is shaped to make the base body of the piercing element, and wherein the base body is cut according to a predetermined pattern to shape, on the plane P of said base body, a plurality of blades. Preferably, the cutting step further provides that the base body is pierced, for example by laser cutting, according to a predetermined pattern to make, on the plane P of the base body, a plurality of through holes.

The method also comprises a further step (b), wherein the blades, whose profile was made by cutting in the preceding step, are folded up for extending from the base body, and in particular from the surface of the base body, along a direction of longitudinal extension which has an angle between 70° and 110°, preferably between 80° and 100°, more preferably substantially equal to 90°, with respect to the base body, and in particular with respect to said surface of the base body.

Advantageously, such method allows the making of the piercing element with very complex geometries in a quick and economic way.

According to an aspect, during the cutting step (a), openings are made by cutting, preferably laser cutting or photoengraving cutting, along the direction of longitudinal extension of the blades.

Preferably, said openings are made by cutting on the plane P of the base body of the piercing element in the shape of substantially linear engravings extending between the two ends, where a first end is placed at the base of said blades and a second end is placed on the body of the blade.

Advantageously, the presence of the openings extending from the base of the blade allows a more effective and improved passage of the water.

The present invention further concerns a machine for preparing beverages (preferably coffee), preferably a machine for preparing espresso coffee, provided with one or more delivery assemblies described and/or claimed herein.

It should be noted that what is described and/or claimed herein with regard to the delivery (infusion) assembly can equally be applied to the piercing element, as well as to the method, and vice versa.

### DESCRIPTION OF THE FIGURES

The characteristics and advantages of the delivery assembly and piercing element according to the invention will become clearer from the description hereunder concerning its preferred embodiments, given by way of example and without limitations, with reference to the accompanying figures, in which:

FIG. 1 is a sectional view of a possible embodiment of the delivery assembly according to the invention;

FIG. 2 is an exploded view of the delivery assembly according to the invention, shown in perspective from the top;

FIG. 3 is an exploded view of the delivery assembly according to FIG. 2, shown in perspective from the bottom;

FIG. 4 is an exploded view of the delivery assembly according to the invention;

FIG. 5 is a sectional view of the delivery assembly according to the invention, which shows the piercing element while piercing the capsule and, schematically, the fluidic path followed by the pressurized hot water.

### DETAILED DESCRIPTION

With reference to the accompanying figures some possible embodiments of the delivery assembly 1 according to the present invention, comprising a piercing element 3 according to the following invention and a respective method of making of the piercer 3 according to the invention, will be described.

The present invention can however be made in many different forms and must not be interpreted as limited to the ones here described hereunder, which are provided by way of example.

The present invention concerns a delivery assembly 1 for a machine for preparing beverages by using capsule preparations 4, which comprises an infusion chamber 100 adapted for inserting and housing the capsule 4 and a delivery unit for delivering pressurized hot water 10, comprising at least one channel 11 for supplying pressurized hot water towards the infusion chamber 100. The components of the machine and, in particular, of the hydraulic circuit, which allow the production of the hot water for preparing the beverage, will not be described in detail herein since they are known in the art.

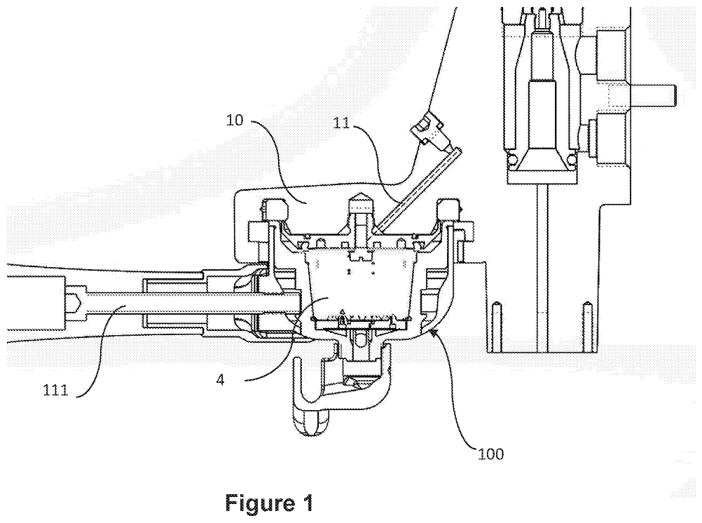

In a preferred embodiment, for example visible in FIG. 1, the infusion chamber 100 comprises a filter-holder 111 provided with a handle, removably constrainable to the delivery unit 10. In other words, according to such embodiment, the capsule is housed in a filter-holder, for example of the type used in the machines for espresso coffee. According to possible embodiments, the infusion chamber and, in particular, the filter-holder, can be provided with piercing means for piercing the capsule outlet section, such as for example needles or points placed on the bottom of the infusion chamber, or on the bottom of the filter-holder.

As is known, the filter-holder can be constrained, preferably removably, to the delivery assembly, for example by connecting means of the bayonet type or by means of flaps intended to cooperate with respective guides placed on the delivery assembly, or vice versa.

The delivery assembly 1 according to the invention further comprises a piercing element 3 for piercing the capsule 4, which has a substantially planar base body 34 and a plurality of blades 32, 32′.

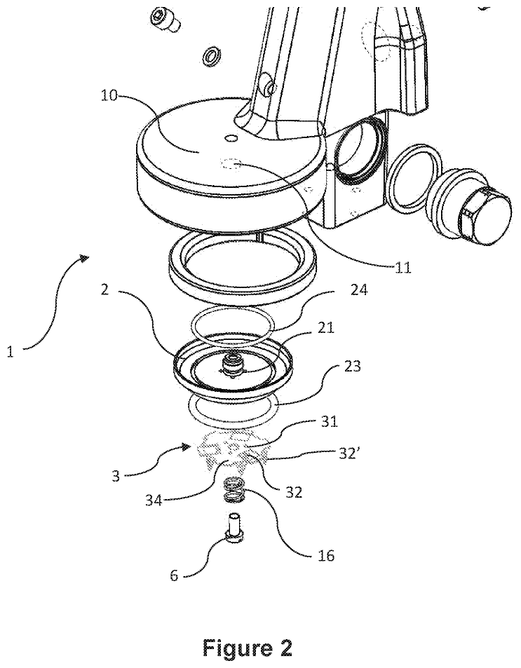

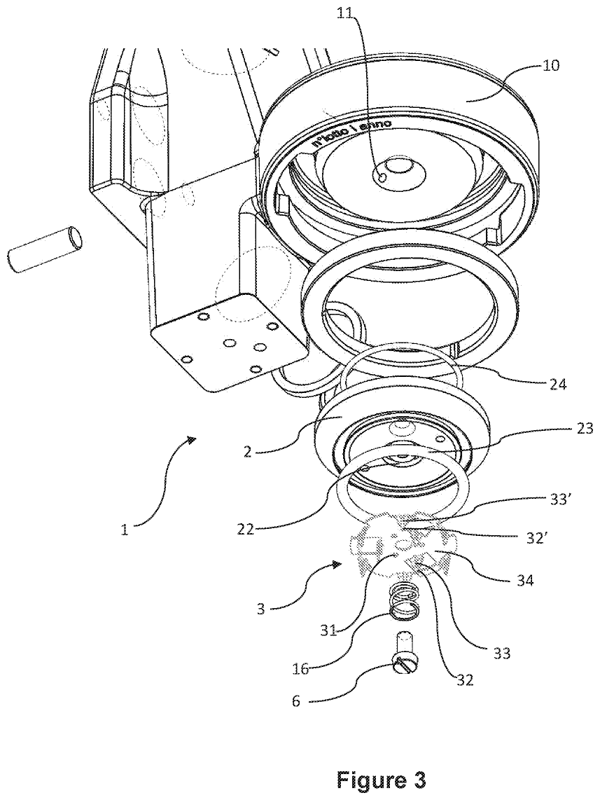

In a possible embodiment, as for example visible in FIGS. 2, 3 and 4, the base body 34 of the piercing element 3 has a substantially circular section, but further embodiments in which the base body of the piercing element 3 has a section of different shape, for example polygonal, are not excluded.

In a possible embodiment, the blades 32, 32′ are made in one piece with the piercing element 3 and preferably each blade 32, 32′ is made from a portion of the piercing element 3 folded up to project towards said infusion chamber 100, for example according to the method of the invention, which will be described hereunder.

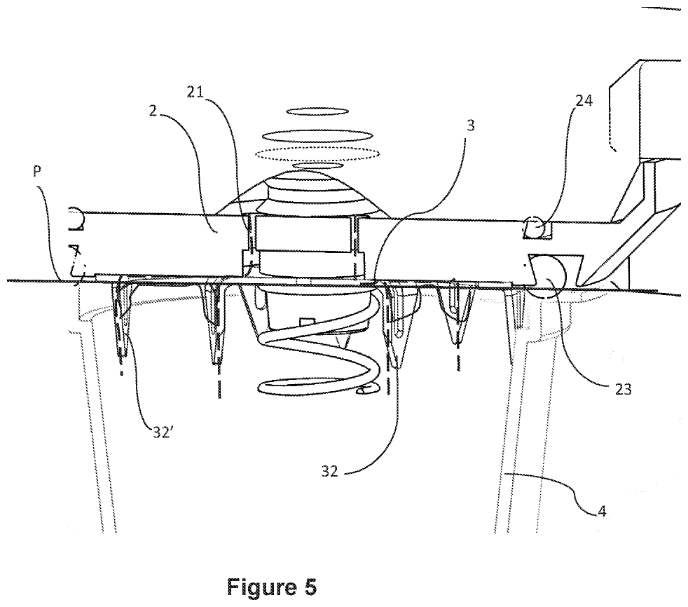

This way, as for example shown in FIG. 5, the blades 32, 32′ extend from the base body 34 of the piercing element to jut out towards the infusion chamber 100, in particular towards the filter-holder 111, such as to allow the piercing of the capsule 4 and in particular of the inlet wall of the capsule housed therein.

The tearing of the film of the capsule, caused by the action of the blades 32, 32′, is further visible schematically in FIG. 5.

In a possible embodiment, the blades 32, 32′ are substantially triangular-shaped.

In a possible embodiment, as for example visible in the figures, the blades 32, 32′ extend from the base body 34 of the piercing element 3 towards the inside of the infusion chamber 100 along a direction of longitudinal extension which has an angle which is preferably substantially equal to 90° with respect to the base body 34 (for example measured with respect to the plane along which the base body extends, or with respect to the surface of the base body facing, in use, the infusion chamber). Despite this, as set forth, possible embodiments wherein the blades extend with an angle between 70° and 110°, preferably between 80° and 100°, with respect to the base body 34 of the piercing element 3 are not excluded.

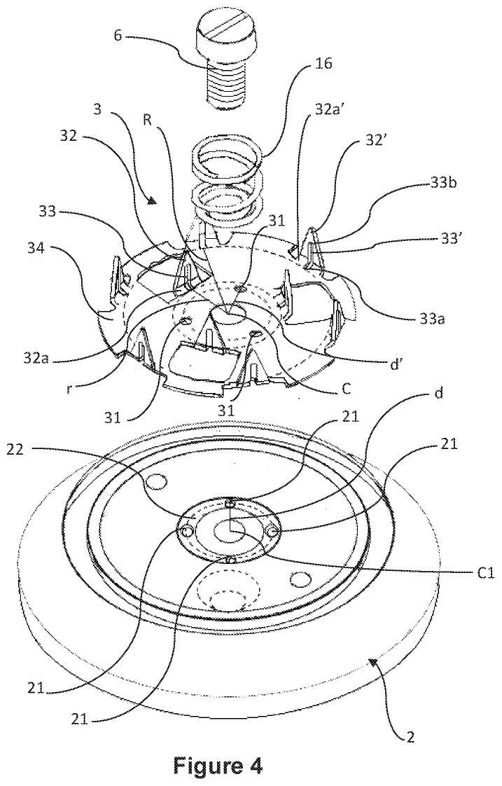

In a preferred embodiment, as for example visible in FIG. 4, the piercing element 3 comprises proximal blades 32 placed at a first radial distance r with respect to the center C of the piercing element 3, preferably along at least one first circumference of radius equal to such first radial distance r, and a plurality of distal blades 32′ placed at a second radial distance R greater than the first radial distance r with respect to the center C of the piercing element 3, and preferably along at least one second circumference of radius R equal to such radial distance R.

According to a possible embodiment, as for example visible in the figures, the piercing element 3 comprises three proximal blades 32 placed at a first radial distance r with respect to the center C of the piercing element 3, and 6 distal blades 32′ placed at a second radial distance R greater than the first radial distance r with respect to the center C of the piercing element 3.

The distal blades 32′ can be placed at the outer perimeter of the base body 34 of the piercing element 3.

In a possible embodiment, as for example visible in FIG. 4, at least one blade 32, 32′, preferably each blade 32, 32′ of the piercing element 3, has an opening 33, 33′ extending from the base body 34 of the piercing element 3 along the direction of longitudinal extension of the blade 32, 32′.

The opening 33, 33′ is preferably made such as to be centered with respect to the sides of the blade, i.e. such as the side edges of the blade are equidistant from the opening.

In such possible embodiment for example visible in FIG. 4, the openings 33, 33′ have a substantially linear shape extending between two ends 33a, 33b, wherein a first end 33a is placed at the base body 34 of the piercing element 3 and a second end 33b is placed on the body of the blade 32, 32′.

Moreover, each of the openings 33, 33′ preferably extends along the respective blade 32, 32′ between the first and second ends 33a, 33b thus forming an angle between 70° and 110°, preferably between 80° and 100°, more preferably substantially equal to 90°, with respect to the base body 34, and in particular with respect to the surface of the base body 34 of the piercing element 3.

As set forth, according to a preferred embodiment, as for example visible in the figures, the openings 33, 33′ follow the extension of the blade and thus, as for example visible in the figures, the openings 33, 33′ extend along the respective blade 32, 32′ between the first and the second ends 33a, 33b thus forming an angle which is preferably substantially equal to 90° with respect to the base body 34 (for example measured with respect to the plane according to which the base body extends, or with respect to the surface of the base body facing, in use, the infusion chamber).

The delivery assembly 1 according to the invention further comprises an intermediate disc 2 in fluidic sealing connection with the delivery unit 10 and interposed between the delivery unit 10 and the piercing element 3.

In a possible embodiment, as for example visible in the figures, the intermediate disc 2 houses, at its lower surface, i.e. the surface facing the infusion chamber, a gasket 23 which allows the hydraulic seal with the underlying capsule, in particular with the perimeter edge (or flange) of the capsule 4 housed inside the infusion chamber 100, with the purpose of preventing flow-rate losses and directing the infusion water inside the capsule.

Moreover, the intermediate disc 2 houses, at its upper surface, i.e. the surface facing the chamber and the delivery unit 10, a gasket 24 which allows the hydraulic seal with the delivery unit 10, in particular with the channel 11 of such delivery unit, with the purpose of preventing flow-rate losses and directing the infusion water towards the infusion chamber 100.

The intermediate disc 2 has a plurality of through openings 21 in fluidic connection with the channel 11 of the delivery unit 10. According to a possible embodiment, the disc 2 comprises four through openings 21, as for example visible in the figures.

The section 21 of the through opening is preferably circular but further shapes of the section are not excluded, as for example the elliptical or polygonal shape.

In a possible embodiment, as for example visible in FIG. 4, the through openings 21 are placed at least at a radial distance d with respect to the center C1 of the intermediate disc 2 and put the channel 11 of the delivery unit 10 in fluidic communication with a circular channel 22 of the intermediate disc 2.

In a possible embodiment, such circular channel 22 is shaped as a groove extending along a circular crown about the center C1 of the intermediate disc 2, on its surface facing the infusion unit 100.

In a preferred embodiment, the circular crown along which such circular channel 22 extends has a radius d equal to the radial distance at which the through openings 21 are placed, such as such through openings 21 are placed along such circular channel 22.

In a preferred embodiment, the circular channel 22 is limited to a little radial extension, such as to extend limitedly about the center C1 of the intermediate disc 2.

In such case, the circular channel 22 extends at a radial distance d with respect to the center C1 which is smaller than the radial distance r at which the proximal points 32 are placed on the piercing element 3, such as the intermediate disc 2 has a flat and continuous leaning surface for the piercing element 2. According to an aspect, the piercing element 3 fully leans on such flat surface of the disc 2, with the exception of such central channel 22.

This characteristic allows to prevent an undesired accumulation of water in the central zone of the delivery assembly, thus preventing to form a chamber with an undesired accumulation of water. Consequently, it is possible to control the amount of water, as well as the flow of water introduced into the capsule, in a precise and effective way.

The piercing element 3 of the delivery assembly 1 according to the invention has a plurality of holes 31 (passing through the thickness of the base body 34, preferably the holes having axes perpendicular to the plane according to which the base body 34 extends) in fluidic connection with the through openings 21 of the intermediate disc to allow the passage of the water towards the infusion unit 100.

According to a possible embodiment, such as for example visible in FIG. 4, there are three holes 31.

According to a possible embodiment, the hole section is circular but further shapes of the section are not excluded, such as for example the elliptical or polygonal shape.

According to a possible embodiment, the holes 31 are placed at least at a radial distance d′ with respect to the center C of the piercing element 3, preferably the holes are placed at the same radial distance d′ with respect to the center C of the piercing element 3.

As for example visible in FIG. 4, the distance d′ at which the holes 31 are placed, with respect to the center C of the piercing element, is smaller than the radial distance r at which the proximal blades 32 of the piercing element 3 are placed.

Moreover, in a preferred embodiment such as for example visible in FIG. 5, the openings 33, 33′ of the blades 32, 32′ are placed in fluidic connection with such through openings 21 of the intermediate disc 2, as for example shown schematically by the dotted line of FIG. 5, which shows the path of the pressurized water towards the infusion chamber 100.

This way, while using the delivery assembly 1, the pressurized hot water can flow from the channel 11 of the delivery unit 10 through the through openings 21 of the intermediate disc, and finally through the holes 31 and the openings 33, 33′ of the blades 32, 32′, such as to be delivered towards the capsule 4 housed inside the infusion unit 100.

In particular, in a possible embodiment, the piercing element 3 is connected with the intermediate disc 2 such as the through openings 21 of the intermediate disc 2 are overlapping the holes 31 of the piercing element 3.

It should be stated that herein and hereunder, the term “overlapping” does not necessarily mean that two elements fully match and are thus aligned (for example, it is not necessary that the holes 31 and the through openings 21 have their respective axes aligned and coinciding with each other). In particular, in the present case for example, it is to be understood that the holes 31 are arranged on the base body 34 of the piercing element 3 along a circumference of radius d′ substantially equal to the radial distance d at which the through openings 21 of the intermediate disc 2 are arranged.

According to possible embodiments, the axes of the holes 31 of the piercing element 3 and the axes of the through openings 21 can be parallel to each other.

In a possible embodiment, the delivery unit 10, the intermediate disc 2 and the piercing element 3 are connected to each other by means of mechanical connecting means, preferably by means of a screw 6.

Moreover, the delivery assembly comprises a central spring 16 calibrated to facilitate the release of the capsule after use.

In particular, in an embodiment, such spring 16 can be positioned about the head of the screw 6, following the insertion of the latter through the delivery assembly 1.

The fluid path traveled by the pressurized hot water coming out of the water delivery unit 10, during use, is briefly described hereunder by way of example. The water coming out of the channel 11 is delivered towards the through openings 21 formed in the intermediate disc 2 and present in a central area of said intermediate disc. Following its passage through such through openings 21, the water is distributed within the circular channel 22 which, as stated, is present between the two facing surfaces of the intermediate disc 2 and the piercing element 3.

Then, the water is delivered into the capsule from the circular channel 22 through the holes 31 of the piercing element and through the openings 33, 33′ of the proximal and distal blades 32, 32′, thus allowing uniform wetting of the powder product contained inside the capsule 4.

The present invention further concerns a piercing element 3 which comprises a substantially planar base body 34, i.e. which predominantly extends in a plane, the third dimension (the thickness) being negligible or anyhow lower than the other two.

In an embodiment, the piercing element 3 is made from a sheet or foil, preferably of metal material.

The piercing element 3 according to the invention has a plurality of blades 32, 32′ which are made in one piece with the piercing element 3 and each blade 32, 32′ is made from a portion of the piercing element 3, folded up for extending from the base body 34 along a direction of longitudinal extension which has an angle between 70° and 110°, preferably between 80° and 100°, more preferably substantially equal to 90° with respect to the base body 34 of the piercing element 3.

According to a preferred embodiment, the piercing element further comprises a plurality of holes 31 passing through the base body 34 and, in particular, which put the two opposite surfaces of the base body 34 of the piercing element in communication.

In a possible embodiment, the blades 32, 32′ are substantially triangular-shaped.

As already discussed above with reference to the delivery assembly, in an embodiment at least one blade 32, 32′, preferably each blade 32, 32′, has an opening 33, 33′ extending from the base body 34 of the piercing element 3 along the direction of longitudinal extension of the blade 32, 32′.

In a preferred embodiment, the openings 33, 33′ are linear openings extending along a central portion of the blades 32, 32′ in their direction of longitudinal extension.

The present invention further concerns a method of making a piercing element 3 according to the invention, wherein the piercing element 3 is made from a sheet, preferably of metal material, and which comprises the steps described hereunder.

During a first cutting step (a), preferably laser cutting, the sheet is shaped to make the base surface 34 of the piercing element 3. In such step, the base surface of the base body 34 leaning on a plane P is cut by cutting, preferably by laser cutting, according to a predetermined pattern to shape, on the plane P of the base surface 34, a plurality of blades 32, 32′.

The base surface 34 can also be pierced by laser cutting according to a predetermined pattern to make, on the plane P of the base surface 34, a plurality of holes 31.

In a second step (b), the blades 32, 32′, for example the proximal blades 32 and the distal blades 32′ made by cutting in the preceding step, are folded up for extending from said base surface 34 along a direction of longitudinal extension which has an angle between 70° and 110°, preferably between 80° and 100°, more preferably substantially equal to 90°, with respect to the surface of the base body 34.

In a possible embodiment, during the cutting step (a), openings 33, 33′ are made by cutting, preferably laser cutting, along the direction of longitudinal extension of the blades 32, 32′.

Preferably, the openings 33, 33′ are made by cutting on the plane P of the base body 34 in the shape of substantially linear engravings extending between two ends 33a, 33b, where a first end 33a is placed at the base 32a, 32a′ of the blade 32, 32′, and a second end 33b is placed on the body of the blade 32, 32′.

It should be observed that, although reference was made to laser cutting, such operation can be performed by means of other cutting technologies, such as for example photoengraving, and in general by means of processes which allow to keep the dimensions whose range of tolerance is very narrow.

The invention claimed is:

1. A delivery assembly (1) for a machine for preparing beverages by using capsule preparations (4), comprising:
an infusion chamber (100) configured for housing said capsule (4);
a delivery unit for delivering pressurized hot water (10), said delivery unit comprising a channel (11) for supplying said pressurized hot water towards said infusion chamber (100);
a piercing element (3) for piercing said capsule (4), said piercing element comprising a planar base body (34) and a plurality of blades (32, 32′); and
an intermediate disc (2) in fluidic sealing connection with said delivery unit (10) and interposed between said delivery unit (10) and said piercing element (3), said intermediate disc comprising a plurality of through openings (21) in fluidic connection with said channel (11) of said delivery unit (10),
wherein said piercing element (3) comprises a plurality of holes (31) in fluidic connection with said through openings (21) of said intermediate disc (2) and placed at least at a radial distance (d′) with respect to a center (C) of said piercing element (3) to allow a passage of the-water towards said infusion chamber (100).

2. The delivery assembly according to claim 1, wherein said holes (31) are placed at a same radial distance (d′) with respect to a center (C) of the piercing element (3).

3. The delivery assembly according to claim 1, wherein said holes (31) are arranged on said base body (34) of the piercing element (3) along a circumference of radius (d′) with respect to a center (C) if the piercing element substantially equal to a radial distance (d) at which said through openings (21) of said intermediate disc (2) are arranged.

4. The delivery assembly according to claim 1, wherein said blades (32, 32′) are made in one piece with said piercing element (3) and extend from said base body (34) to project towards said infusion chamber (100).

5. The delivery assembly according to claim 1, wherein at least one blade of said plurality of blades (32, 32′) has a blade opening (33, 33′) extending from the base body (34) of said piercing element (3) along a direction of longitudinal extension of the at least one blade (32, 32′), and wherein said blade opening (33, 33′) is placed in fluidic connection with said through openings (21) of the intermediate disc (2).

6. The delivery assembly (1) according to claim 1, wherein said piercing element (3) comprises proximal blades (32) placed at a first radial distance (r) with respect to a center (C) of said piercing element (3), and a plurality of distal blades (32′) placed at a second radial distance (R) greater than said first radial distance (r) with respect to the center (C) of said piercing element (3).

7. The delivery assembly (1) according to claim 1, wherein said through openings (21) are placed at least at a radial distance (d) with respect to a center (C1) of said intermediate disc (2) and put said channel (11) of said delivery unit (10) in fluidic communication with a circular channel (22) of said intermediate disc (2).

8. The delivery assembly (1) according to claim 7, wherein said circular channel (22) of said intermediate disc (2) is shaped as a groove extending along a circular crown about the center (C1) of said intermediate disc (2), on a surface of said intermediate disc (2) facing the infusion chamber (100).

9. The delivery assembly (1) according to claim 1, wherein said piercing element (3) is connected with said intermediate disc (2) such as said through openings (21) of said intermediate disc (2) are overlapping said holes (31) of said piercing element (3).

10. The delivery assembly (1) according to claim 1, wherein said delivery unit (10), said intermediate disc (2) and said piercing element (3) are connected to each other by a mechanical connector.

11. The delivery assembly (1) according to claim 1, wherein said piercing element (3) is made from a sheet or foil of material.

12. The delivery assembly (1) according to claim 1, wherein said blades (32, 32′) are triangular-shaped.

13. The delivery assembly (1) according to claim 1, wherein said blades (32, 32′) extend from the base body (34) of said piercing element (3) towards an inside of said infusion chamber (100) along a direction of longitudinal extension which has an angle between 70° and 110° with respect to the base body (34) of said piercing element (3).

14. The delivery assembly (1) according to claim 1, wherein said openings (33, 33′) have a substantially linear shape extending between two ends (33a, 33b), and wherein a first end (33a) of said substantially linear shape is placed at the base body (34) of said piercing element (3) and a second end (33b) is placed on a body of one of the plurality of blades (32, 32′).

15. The delivery assembly (1) according to claim 14, wherein each of said openings (33, 33′) extends along a respective blade (32, 32′) between said first and said second ends (33a, 33b) thus forming an angle between 70° and 110°, with respect to the base body (34) of said piercing element (3).

16. The delivery assembly (1) according to claim 1, wherein said infusion chamber is a filter-holder provided with a handle, said filter-holder being removably constrainable to said delivery unit (10) by connecting means.

17. A piercing element (3) comprising:
a planar base body (34); and
a plurality of blades (32, 32′),
wherein a plurality of holes (31)is defined on said base body (34), and
wherein said blades (32, 32′) are made in one piece with said piercing element (3) and each blade (32, 32′) is made from a portion of said piercing element (3), folded up for extending from a base surface of said planar base body (34) along a direction of longitudinal extension which has an angle between 70° and 110° with respect to the base body (34) of said piercing element.

18. The piercing element (3) according to claim 17, wherein at least one blade (32, 32′) of said plurality of blades has an opening (33, 33′) extending from the planar base body (34) of said piercing element (3) along a direction of longitudinal extension of the at least one blade (32, 32′).

19. A method of making a piercing element (3) according to claim 17, wherein said piercing element (3) is made from a sheet, of material, the method comprising:
a cutting step (a), wherein the sheet is shaped to make the base body (34) of said piercing element, and wherein the base body (34) is cut according to a predetermined pattern to shape, on a plane (P) of said base body (34), the plurality of blades (32, 32′); and
a folding step (b), wherein said blades (32, 32′) are folded up for extending from said base surface (34) along a direction of longitudinal extent which has an angle between 70° and 110° with respect to said base body (34).

20. The method according to claim 19, wherein, in said cutting step (a), the base body (34) is pierced by cutting according to a predetermined pattern for making a plurality of holes (31).

21. The method according to claim 19, wherein, in said cutting step (a), openings (33, 33′) are made by cutting along the direction of longitudinal extension of said blades (32, 32′), in the plane (P) of said base body (34) as substantially linear engravings extending between two ends (33a, 33b), where a first end (33a) of said two ends is placed at a base (32a, 32a′) of said blades (32, 32′), and a second end (33b) is placed on a body of the blade (32, 32′).
